(19) United States
(12) Patent Application Publication
(10) Pub. No.: US 2016/0085313 A1
(43) Pub. Date: Mar. 24, 2016

(54) ELECTRONIC DEVICE, CONTROL SYSTEM AND CONTROL METHOD FOR SMART GLASS

(71) Applicant: HON HAI PRECISION INDUSTRY CO., LTD., New Taipei (TW)

(72) Inventors: CHIA-JOU HUANG, New Taipei (TW); PO-HSIEN LIU, New Taipei (TW)

(21) Appl. No.: 14/700,410

(22) Filed: Apr. 30, 2015

(30) Foreign Application Priority Data
Sep. 24, 2014 (TW) 103132958

(51) Int. Cl. G06F 3/01

(52) U.S. Cl. CPC G06F 3/017

(57) ABSTRACT

A control method for smart glass is provided. The control method includes: recognizing a gesture in response of an input signals; comparing the gesture with a number of predefined gestures stored in the electronic device; determining whether the gesture is similar to one of the number of predefined gestures; obtaining the one of the number of predefined gestures when the gesture is similar to the one of the number of predefined gestures; submitting an instruction containing the one of the number of predefined gestures to a smart glass; analyzing the instruction to get the one of the number of predefined gestures; obtaining a control order matched with the one of the number of predefined gestures stored in the smart glass; and controlling a display unit of the smart glass to refresh contents according to the control order.

### FIELD

The subject matter herein generally relates to electronic devices, control systems and control methods for smart glasses, especially to an electronic device with function of controlling smart glass, and a control system and a control method for controlling the smart glass.

### BACKGROUND

Smart glass can be used by many users. The smart glass can be used to watch many information, such as news, movies, or so on.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of a control system for smart glass.

FIG. 2 is a block diagram of an embodiment of an operating environment of the control system for smart glass shown in FIG. 1.

FIG. 3 is a flowchart of an embodiment of a control method for smart glass.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

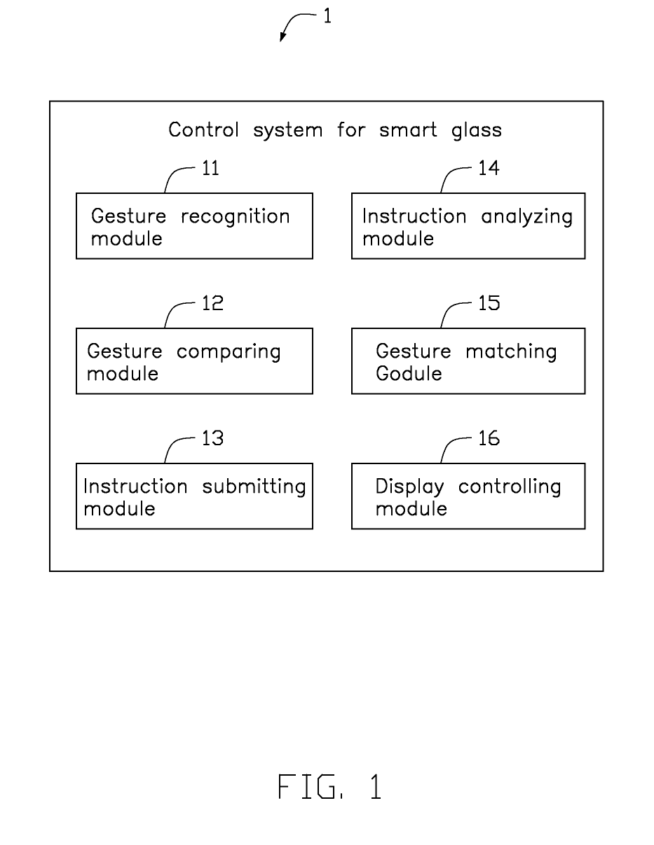

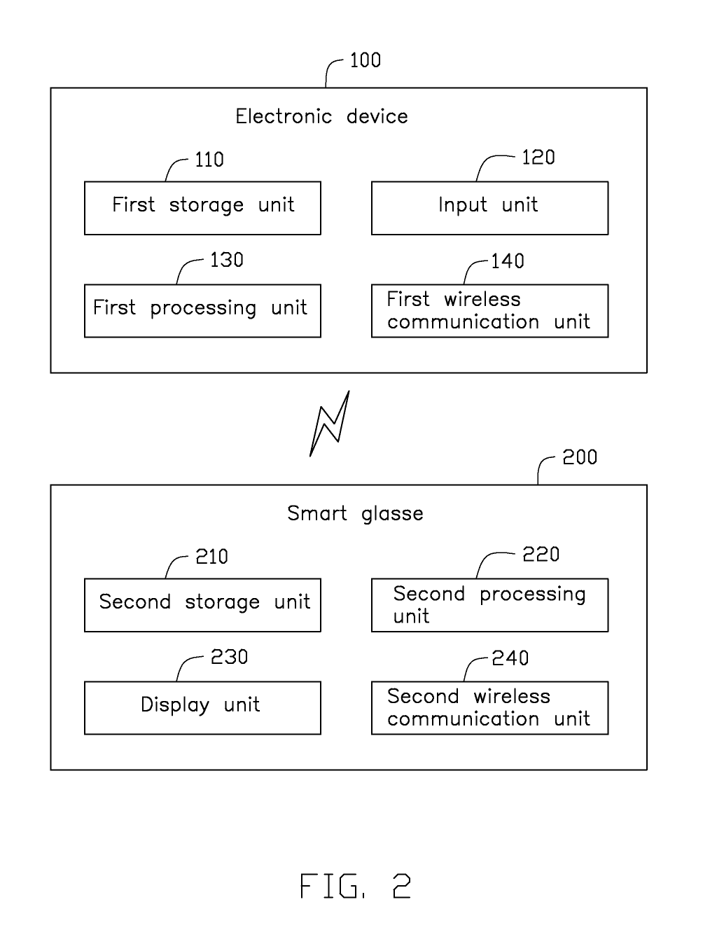

FIG. 1 shows a control system for smart glass 1. The control system for smart glass 1 can be run on but not limited to an electronic device 100 and a smart glass 200 which are shown on FIG. 2.

The electronic device 100 can be a mobile phone, or a computer includes, but not limited to, a portable computer, or a tablet computer, or a desktop computer. The electronic device 100 can include a first storage unit 110, an input unit 120, a first processing unit 130 and a first wireless communication unit 140.

The first storage unit 110 can store a number of predefined gestures, such as a gesture of sliding up, sliding down, sliding a circle, sliding a triangle, or the like.

In at least one embodiment, the first storage unit 110 can further store a number of serial numbers corresponding to the number of predefined gestures.

The input unit 120 can be used to generate input signals in response of a user's input operations applied thereon. In at least one embodiment, the input unit 120 can be a touch screen, a touchpad, or other suitable devices with input functions.

The first wireless communication unit 140 can be a Bluetooth, a Low-power Bluetooth, or other suitable devices with functions of short-distance communications. The electronic device 100 can communicate with the smart glass 200 via the first wireless communication unit 140.

The smart glass 200 can include a second storage unit 210, a second processing unit 220, a display unit 230 and a second wireless communication unit 240.

The second storage unit 210 can store a number of predefined gestures. The number of predefined gestures can be same to the number of predefined gestures stored in the first storage unit 110. The second storage unit 210 can further store a relationship recording the number of predefined gestures and a number of control orders, such as a sliding up gesture is corresponded to a control order of page up, or a sliding down gesture is corresponded to a control order of page down.

In at least one embodiment, the second storage unit 210 can further store a number of serial numbers corresponding to the number of predefined gestures.

The second wireless communication unit 240 can be Bluetooth, Low-power Bluetooth, or other suitable devices with functions of short-distance communications. The smart glass 200 can communicate with the electronic device 100 via the second wireless communication unit 240.

In at least one embodiment, the first storage unit 110 and the second storage unit 210 can be an internal storage system, such as a flash memory, a random access memory (RAM) for temporary storage of information, and/or a read-memory (ROM) for permanent storage of information.

In at least one embodiment, the first storage unit 110 and the second storage unit 210 can also be a storage system, such as a hard disk, a storage card, or a data storage medium. The first storage unit 110 and the second storage unit 210 can include volatile and/or non-volatile storage devices.

In at least one embodiment, the first storage unit 110 and the second storage unit 210 can include two or more storage devices such that one storage device is a memory and the other storage device is a hard drive. Additionally, the first storage unit 110 and the second storage unit 210 can be respectively located either entirely or partially external relative to the vehicle 100 or the smart key 200.

In at least one embodiment, the first processing unit 130 and the second processing unit 230 can be a central processing unit, a digital signal processor, or a single chip, for example.

The control system for smart glass 1 can include a number of modules, and the number of modules can include a gesture recognition module 11, a gesture comparing module 12, an instruction submitting module 13, an instruction analyzing module 14, a gesture matching module 15 and a display controlling module 16. The number of modules can be stored in the first storage unit 110 and/or second storage unit 210, and further applied on the first processing unit 130 and/or second processing unit 220. In this embodiment, the gesture recognition module 11, the gesture comparing module 12 and the instruction submitting module 13 can be stored in the first storage unit 110, and applied on the first processing unit 130. The instruction analyzing module 14, the gesture matching module 15 and the display controlling module 16 can be stored in the second storage unit 210, and applied on the second processing unit 220. The details are as follows.

The gesture recognition module 11 can be used to recognize a gesture in response of the input signals.

The gesture comparing module 12 can be used to compare the gesture with the number of predefined gestures stored in the first storage unit 110, and determine whether the gesture is similar to one of the number of predefined gestures, and further obtain the one of the number of predefined gestures and/or the serial number of the one of the number of predefined gestures when determined that the gesture is similar to the one of the number of predefined gestures.

The instruction submitting module 13 can be used to control the first wireless communication unit 140 to submit an instruction containing the one of the number of predefined gestures and/or the serial number of the one of the number of predefined gestures.

The second wireless communication unit 240 can receive the instruction.

The instruction analyzing module 14 can be used to analyze the instruction to get the one of the number of predefined gestures and/or the serial number of the one of the number of predefined gestures.

The gesture matching module 15 can be used to obtain a control order matched with the one of the number of predefined gestures and/or the serial number of the one of the number of predefined gestures.

The display control module 16 can be used to control the display unit 230 to refresh the contents according to the control order.

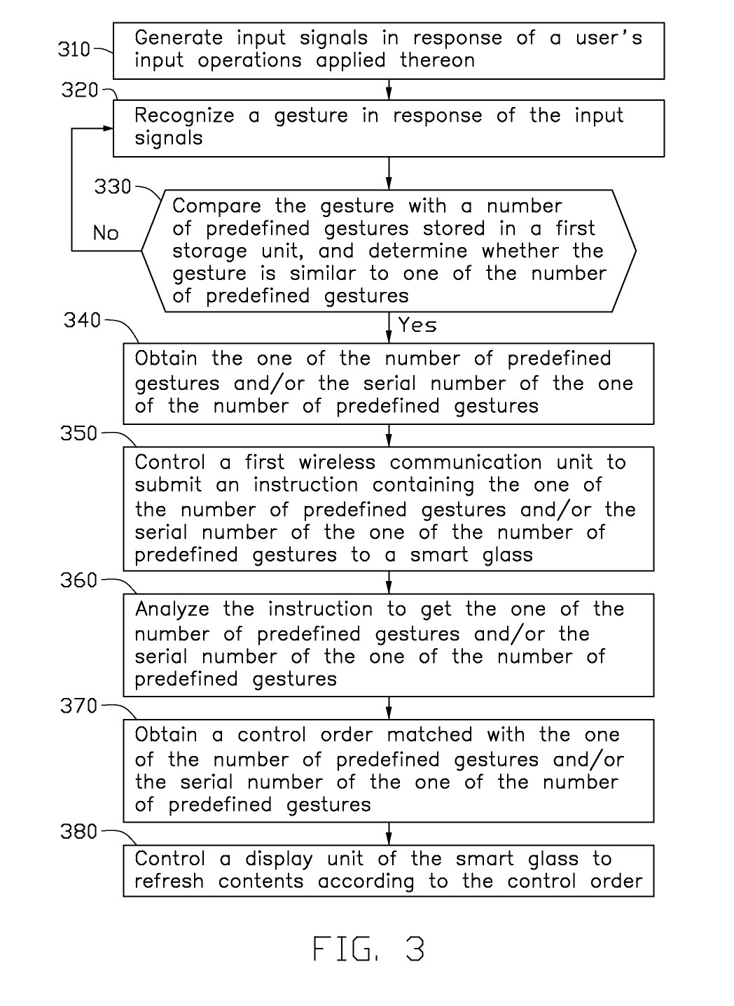

FIG. 3 illustrates a flowchart of a control method for smart glass. The control method is provided by way of example, as there are a variety of ways to carry out the method. The control method described below can be carried out using the configurations illustrated in FIG. 1, for example, and various elements of these figures are referenced in explaining the example method. Each block shown in FIG. 3 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 310.

At block 310, an input unit generates input signals in response of a user's input operations applied thereon.

At block 320, a gesture recognition module recognizes a gesture in response of the input signals.

At block 330, a gesture comparing module compares the gesture with the number of predefined gestures stored in a first storage unit, and determine whether the gesture is similar to one of the number of predefined gestures, if yes, the process goes to block 340, otherwise, the process returns to block 320.

At block 340, the gesture comparing module obtains the one of the number of predefined gestures and/or the serial number of the one of the number of predefined gestures.

At block 350, an instruction submitting module controls a first wireless communication unit to submit an instruction containing the one of the number of predefined gestures and/or the serial number of the one of the number of predefined gestures to a smart glass.

At block 360, an instruction analyzing module analyzes the instruction to get the one of the number of predefined gestures and/or the serial number of the one of the number of predefined gestures.

At block 370, a gesture matching module obtains a control order matched with the one of the number of predefined gestures and/or the serial number of the one of the number of predefined gestures.

At block 380, a display control module controls a display unit of the smart glass to refresh the contents according to the control order.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A control system for smart glass, running on an electronic device and a smart glass, the control system comprising:
a plurality of processing units; and
a plurality of modules coupled to the plurality of processing units, each of the plurality of modules including instructions to be executed by one or more of the plurality of processing units, the plurality of modules comprising:
a gesture recognition module configured to, upon execution by the plurality of processing units, cause the plurality of processing units to recognize a gesture in response to input signals, wherein the input signals are generated by an input unit of the electronic device in response of input operations applied thereon;
a gesture comparing module configured to, upon execution by the plurality of processing units, cause the plurality of processing units to compare the gesture with a plurality of predefined gestures stored in a first storage unit of the electronic device, determine whether the gesture is similar to one of the plurality of predefined gestures, and further obtain the one of the plurality of predefined gestures when the gesture is similar to the one of the plurality of predefined gestures;
an instruction submitting module configured to, upon execution by the plurality of processing units, cause the plurality of processing units to control a first wireless communication unit of the electronic device to submit an instruction containing the one of the plurality of predefined gestures to the smart glass;
an instruction analyzing module configured to, upon execution by the plurality of processing units, cause the plurality of processing units to analyze the instruction to get the one of the plurality of predefined gestures;
a gesture matching module configured to, upon execution by the plurality of processing units, cause the plurality of processing units to obtain a control order matched with the one of the plurality of predefined gestures from a second storage unit of the smart key; and
a display control module configured to, upon execution by the plurality of processing units, cause the plurality of processing units to control a display unit of the smart key to refresh contents according to the control order.

2. The control system of claim 1, wherein the gesture recognition module, the gesture comparing module and the instruction submitting module are stored in the first storage unit, and executed by the processing units of the electronic device, and the instruction analyzing module, the gesture matching module and the display controlling module are stored in the second storage unit, and executed by the processing units of the smart glass.

3. The control system of claim 1, wherein the first storage unit further stores a plurality of serial numbers corresponding to the plurality of predefined gestures, the second storage unit further stores a plurality of serial numbers corresponding to the plurality of predefined gestures; the instruction further contains the serial number of the one of the plurality of predefined gestures to the smart glass; the instruction analyzing module is further configured to analyze the instruction to get the serial number of the one of the plurality of predefined gestures; the gesture matching module is further configured to obtain the control order matched with the serial number of the one of the plurality of predefined gestures.

4. An electronic device comprising:
a storage unit storing a plurality of predefined gestures;
an input unit generating input signals in response of input operations applied thereon;
a wireless communication unit configured to establish a communication between the electronic device and a smart glass;
a gesture recognition module configured to recognize a gesture in response of the input signals;
a gesture comparing module configured to compare the gesture with the plurality of predefined gestures stored in the first storage unit, and determine whether the gesture is same to one of the plurality of predefined gestures, and further obtain the one of the plurality of predefined gestures when determined that the gesture is similar to the one of the plurality of predefined gestures; and
an instruction submitting module configured to control the wireless communication unit to submit an instruction containing the one of the plurality of predefined gestures to the smart glass; wherein the instruction is configured to control a smart glass.

5. The electronic device of claim 4, wherein the storage unit further stores a plurality of serial numbers corresponding to the plurality of predefined gestures; the instruction further contains the serial plurality of the one of the plurality of predefined gestures.

6. A control method for smart glass, for smart glass, running on an electronic device and a smart glass, the control method comprising:
recognizing a gesture in response to input signals, wherein the input signals are generated by an input unit of the electronic device in response of input operations applied thereon;
comparing the gesture with a plurality of predefined gestures stored in a first storage unit of the electronic device, and determining whether the gesture is similar to one of the plurality of predefined gestures;
obtaining the one of the plurality of predefined gestures when the gesture is similar to the one of the plurality of predefined gestures;
controlling a first wireless communication unit of the electronic device to submit an instruction containing the one of the plurality of predefined gestures to the smart glass;
analyzing the instruction to get the one of the plurality of predefined gestures;
obtaining a control order matched with the one of the plurality of predefined gestures from a second storage unit of the smart key; and
controlling a display unit of the smart key to refresh contents according to the control order.

7. The control method of claim 6, wherein the first storage unit further stores a plurality of serial numbers corresponding to the plurality of predefined gestures, the second storage unit further stores a plurality of serial numbers corresponding to the plurality of predefined gestures; the control method further comprises:
controlling the first wireless communication unit to submit an instruction containing the serial number of the one of the plurality of predefined gestures to the smart glass;
analyzing the instruction to get the serial number of the one of the plurality of predefined gestures;
obtaining the control order matched with the serial number of the one of the plurality of predefined gestures; and
controlling the display unit to refresh contents according to the control order.
